(19) United States
(12) Patent Application Publication
(10) Pub. No.: US 2026/0195883 A1
(43) Pub. Date: Jul. 9, 2026

(54) AUTOMATED MACROGRAPHIC SECTION ANALYSIS OF JOINTS

(71) Applicant: MAGNA INTERNATIONAL INC., Aurora (CA)

(72) Inventors: Eric deNIJS, Toronto (CA); Patrick HENRI, Ajax (CA); Pavlo PENNER, Brampton (CA); Daniel LI, Troy, MI (US)

(21) Appl. No.: 19/132,070

(22) PCT Filed: Nov. 21, 2023
(86) PCT No.: PCT/US2023/080664

§ 371 Date: May 22, 2025

Related U.S. Application Data
(60) Provisional application No. 63/427,115, filed on Nov. 22, 2022.

(51) Int. Cl. G06T 7/00; G06V 10/764

(52) U.S. Cl. CPC G06T 7/0004; G06V 10/764; G06T 2207/20081; G06T 2207/20084

(57) ABSTRACT

A method for analyzing a cross-section of a joint includes: capturing, using a camera, an image of the cross-section of the joint; analyzing, using one or more neural networks, the image of the cross-section of the joint to classify two or more body segments that comprise the joint; isolating, using the one or more neural networks, the body segments of the joint; reassembling the body segments to form an assembled image of the joint; identifying key points in the assembled image of the joint; and measuring, using the key points, a value for a characteristic of the joint. A system for automated sectional analysis of a joint is also provided.

### CROSS-REFERENCE TO RELATED APPLICATIONS

This PCT International Patent application claims the benefit of and priority to U.S. Provisional Patent Application Ser. No. 63/427,115, filed Nov. 22, 2022, titled “Automated Macrographic Section Analysis Of Joints,” the entire disclosure of which is hereby incorporated by reference in its entirety.

### FIELD

The present disclosure relates generally to sectional analysis of welds joining two or more pieces of metal. More specifically, the present disclosure relates to automated systems and methods for analyzing such welds.

### BACKGROUND

Periodic destructive testing of joints between workpieces, such as self-piercing rivets (SPR), brazing, laser welds, spot welds, or Gas Metal Arc Welds (GMAW), is a common testing requirement to ensure quality of such joints. Different stakeholders, such as original equipment manufacturers (OEMs) may have performance requirements or standards for testing of GMAWs.

The destructive testing process may involve extracting one or more axial cross-section(s) of the weld, polishing, etching to improve the contrast between the weld and the base material, and inspection of the polished and etched cross-section by a skilled operator using a magnified imaging system. The inspection process often requires both measurement of the weld dimensions and identification of defects in the weld, if any exist. The results of the testing are added to a report and used as a quality management tool. This process is very time consuming and labor intensive. Thus, there is a significant direct labor cost.

The conventional inspection process requires skilled operators, adding to the cost of the operation. Due to the length of time required to process many welds on a product, it can take several hours or days between the time the product is produced and the final quality report is generated. Such delay may result in hundreds of defective parts being produced before an issue is identified.

Furthermore, some OEMs require the testing be completed and quality confirmed before an entire batch of products can be shipped to the OEM for installation in an assembled product, such as an automobile. This process known as “batch and hold” results in significant storage, management and logistics costs.

Quality reports and related measurement data is often presented and stored in a format that can be difficult to track over time and correlate to welding process data. This can limit the value of the data for process improvement.

Finally, as with any human dependent process, there can be some variation in methodology and procedure that can introduce inconsistency and/or errors in testing results.

### SUMMARY

The present disclosure provides a method for analyzing a cross-section of a joint between two workpieces. The method includes: capturing, using a camera, an image of the cross-section of the joint; analyzing, using a machine learning technique, the image of the cross-section of the joint to classify two or more body segments that comprise the joint; isolating, using the machine learning technique, the body segments of the joint; reassembling the body segments to form an assembled image of the joint; identifying key points in the assembled image of the joint; and measuring, using the key points, a value for a characteristic of the joint.

The present disclosure also provides a method for analyzing a cross-section of a joint between two workpieces. The method includes: capturing, using a camera, an image of the cross-section of the joint; analyzing, using a machine learning technique, the image of the cross-section of the joint to classify two or more body segments that comprise the joint; isolating, using the machine learning technique, the body segments of the joint; reassembling the body segments to form an assembled image of the joint; and determining, based on the body segments, a characteristic indicative of a defect in the joint.

The present disclosure also provides a system for automated sectional analysis of a joint between two workpieces. The system includes: a processor; and a memory that includes instructions. The instructions, when executed by the processor, cause the processor to: analyze, using a machine learning technique, an image of a cross-section of the joint to classify two or more body segments that comprise the joint; isolate, using the machine learning technique, the body segments of the joint; reassemble the body segments to form an assembled image of the joint identify key points in the assembled image of the joint; and measure, using the key points, a value for a characteristic of the joint.

### BRIEF DESCRIPTION OF THE DRAWINGS

Further details, features and advantages of designs of the invention result from the following description of embodiment examples in reference to the associated drawings.

FIG. 1 shows a block diagram of a system for automated sectional analysis of welds, in accordance with the present disclosure;

FIG. 2 shows a flow diagram illustrating steps in a method for sectional analysis of welds;

FIG. 3 shows a cross-sectional image of a weld connecting two metal pieces;

FIGS. 4A-4C show three isolated body segments based on the cross-sectional image of FIG. 3;

FIG. 5 shows a reassembled image including the three isolated body segments of the FIGS. 4A-4C, and with key points in the weld identified;

FIG. 6 shows the reassembled image of FIG. 5 and with lines indicating weld measurements;

FIG. 7 shows a flow chart of steps in a method for automated inspection of welds, in accordance with the present disclosure;

FIG. 8 shows a flows chart of sub-steps for automated image processing in the method of FIG. 7;

FIG. 9 shows a series of training images used for training an Artificial Intelligence (AI) model, in accordance with the present disclosure;

FIG. 10 shows a cross-sectional image of a weld, illustrating features of a semantic segmentation method in accordance with the present disclosure;

FIG. 11 shows a cross-sectional image of a first weld, illustrating weld characteristics to be measured by the method and system of the present disclosure;

FIG. 12 shows a cross-sectional image of a second weld, illustrating weld characteristics to be measured by the method and system of the present disclosure;

FIG. 13A shows a cross-sectional image of a weld joining two metal pieces, with lines indicating measurements determined by a manual inspection process;

FIG. 13B shows the cross-sectional image of the weld of FIG. 13A, with lines indicating measurements determined by the automated system and method in accordance with the present disclosure; and

FIG. 14 shows an architecture diagram of the system for automated sectional analysis of joints, such as welds, in accordance with the present disclosure.

### DETAILED DESCRIPTION

Referring to the drawings, the present invention will be described in detail in view of following embodiments.

It is an objective of the system and method of the present disclosure to reduce time and labor associated with inspection and measurement of weld cross-section images. The system and method of the present disclosure may reduce direct labor costs of image inspection and measurement, and reduce the total time for report generation. The system and method of the present disclosure can provide faster process control and reduce batch-and-hold costs, when compared with conventional manual processes. Additionally, the system and method of the present disclosure will improve data storage and availability to enable improved reporting, processing monitoring, and correlation. By automating steps in a process of inspection and measurement of weld cross-section images, variation and human error can be reduced or eliminated, resulting in more consistent and more reliable weld cross-section inspection and measurement.

The system and method of the present disclosure may reduce cycle time of processing macrographic images of weld cross-sections by automatically inspecting and measuring the samples. Unless otherwise defined, macrographic images are images that are enlarged or otherwise provided at scale at which relevant features are visible to the naked eye. A macrographic image may have a magnification scale of between 1.0 times and 10 times magnification.

The method of the present disclosure may include: 1. Utilize trained neural networks and machine vision algorithms to segment the weld pool and base materials from the image; 2. Use the bodies along with a pixels/mm calibration to measure the characteristics of the weld using algorithms; 3. Identify and measure, as required, weld defects (undercut, porosity, melt-through, etc.) using additional neural networks and machine vision algorithms; 4. Display predicted results to operator for confirmation and adjustment, as requited; and 5. Automatically generate reports and add weld information and measurements to database for use in other dashboards and displays

The system and method of the present disclosure may employ Semantic Segmentation Neural Network Models in the trained models used to predict the bodies within the weld cross-section image. There may be several different trained models to predict bodies from varying weld joint types, geometry, size, material and to detect defects.

The system and method of the present disclosure may employ Data Annotation: Training & Test Sets for training the segmentation neural network models and to evaluate their performance. A set of general logical rules, which may be called a Semantic Segmentation Algorithm, may be used to measure the weld characteristics based on the segmented bodies predicted by the neural network. There may be several different sets of rules to enable measurement of different joint types, customer specifications, and the presence of defects. The semantic segmentation algorithm may attempt to predict, for example, weld characteristics.

The system and method of the present disclosure may provide high-speed sample processing. By automating the measurement of weld characteristics, a single operator can process samples at a much higher rate. The system and method of the present disclosure may provide improved flexibility over conventional systems and methods. The same trained neural network can be used for a variety of weld joint types and products with little or no customization. Thus, the system and method of the present disclosure can yield a greater cost savings with lower up-front investment. The system and method of the present disclosure may also provide improvements in robustness. Trained neural networks are much more robust to changing image conditions than traditional machine vision and image processing algorithms. This reduces the chance and severity of errors in processing a high volume of images. Furthermore, the system can evolve as new images and conditions are added to the training set.

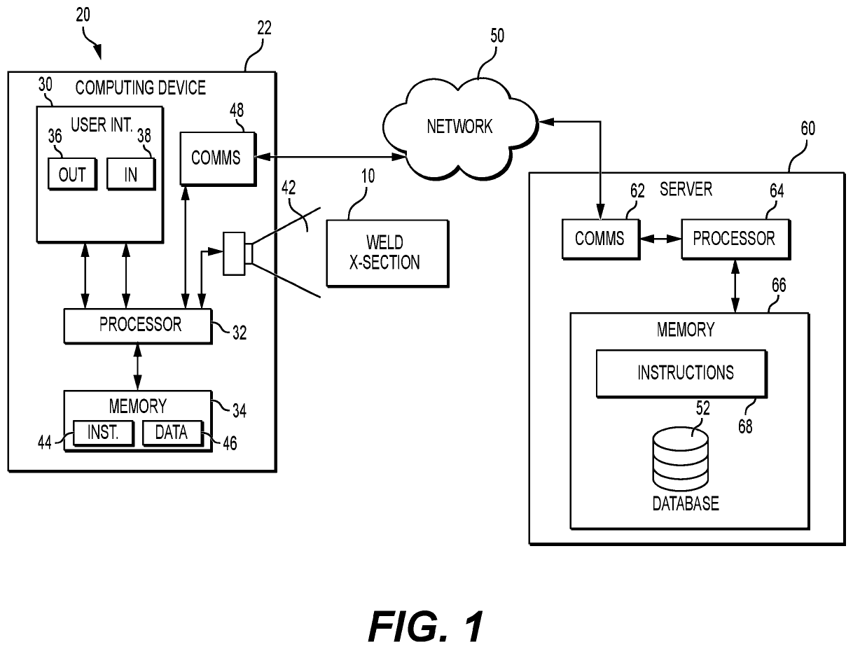

As shown in FIG. 1, an automated inspection system 20 for automated analysis of a cross-section of a weld 10 is provided. The inspection system 20 includes a computing device 22 which is configured to perform some or all functions of the automated inspection system 20. The computing device 22 may include a tablet, such as an iPad, or an Android or Windows tablet device. The computing device 22 may be another type of device, such as a smartphone, smart glasses, a laptop, netbook, etc. In some embodiments, the computing device 22 may include a tablet due to the high processor performance, long battery life, ease of use, and relatively low cost.

As illustrated in the example embodiment shown in the block diagram of FIG. 1, the computing device 22 includes a user interface 30, and a first processor 32 coupled to a first machine-readable storage memory 34. The user interface 30 includes an output device 36 configured to present output data to a user, and an input device 38 configured to receive input data from the user. The output device 36 may include a video display, such as a display screen, a projected display, or a virtual-reality (VR) or augmented reality (AR) image. Alternatively or additionally, the output device 36 may include audio output, such as one or more speakers providing the output in the form of audible signals. The input device 38 may include a touch-screen, a keyboard, mouse, trackpad, trackball, gesture input. Alternatively or additionally, the input device 38 may include hardware and/or software to respond to verbal commands. The output device 36 may be combined with the input device 38, for example, as a touch screen.

The computing device 22 includes a camera 40 having a field of view 42 for viewing the cross-section of the weld 10. The camera 40 may be configured to capture images of the cross-section of the weld 10 in the visible light spectrum. Alternatively or additionally, the camera 40 may use other non-visible wavelengths, such as infrared (IR) and/or ultraviolet (UV). The camera 40 may be configured to capture video, which may be presented on the output device 36 as a live image. Alternatively or additionally, the camera 40 may be configured to capture still images of the field of view 42, including images of the cross-section of the weld 10. The video and/or still images captured by the camera 40 may be saved in memory for future use. In some embodiments, an inverted microscope may be used, with the field of view 42 of the camera 40 looking upward toward the cross-section of the weld 10. Such an inverted microscope may allow gravity to assist holding the cross-section of the weld 10 on a flat surface.

As also shown in FIG. 1, the computing device 22 includes a first communications interface 48 configured to transmit and to receive data to/from a server 60 via a network 50. The first communications interface 48 may include a wired or a wireless interface, such as, for example, a Universal Serial Bus (USB) or Ethernet interface, or a Wi-Fi, ZigBee, or cellular data radio. The network 50 may include one or more wired and/or wireless segments, which may include, for example, Wi-Fi, ZigBee, Ethernet, infrared, etc.

The first machine-readable storage memory 34 may include one or more of a RAM memory, a ROM memory, flash, or DRAM and may include magnetic, optical, semiconductor, or another type of machine-readable storage. The computing device 22 also includes first instructions 44 stored in the first machine-readable storage memory 34 for directing the first processor 32 to cause the output device 36 to present particular output data to the user, and to cause the first processor 32 to receive feedback from the user via the input device 38 and to store data in a first data storage region 46 of the first storage memory 34 and to transmit the data to the server 60. The first instructions 44 may include compiled or interpreted data instructions that cause the first processor 32 to perform operations to enable functions of the automated inspection system 20.

The server 60 includes a second communications interface 62 for communicating with the computing device 22 and/or for communicating with the computing device 22. The second communications interface 62 may include one or more wired and/or wireless interfaces, which may be the same type or a different type as the first communications interface 48. The server 60 also includes a second processor 64 and a second machine-readable storage memory 66 including second instructions 68 and a second data storage region 52 for storing data. The second data storage region 52 may be organized as a database, as shown on FIG. 1. Alternatively or additionally, data may be stored on an external database that is outside of the second machine-readable storage memory 66 of the server 60. For example, the data may be hosted on a dedicated database.

The second instructions 68 may be configured to cause the second processor 64 to store and analyze the data.

Either or both of the first processor 32 and/or the second processor 64 may be configured process one or more images captured by the camera 40 and to implement one or more functions, such as machine learning (ML) and/or artificial intelligence (AI) processing for automated analysis of the cross-section of the weld 10. For example, the first processor 32 and/or the second processor 64 may work in conjunction to analyze the images captured by the camera to generate a binary segmented image, to locate the key points, and to calculate measurements for characteristics of the weld 10 based on the binary segmented image. Either or both of the first processor 32 and/or the second processor 64 may be further configured to generate reports listing measured values for several characteristics of the weld 10.

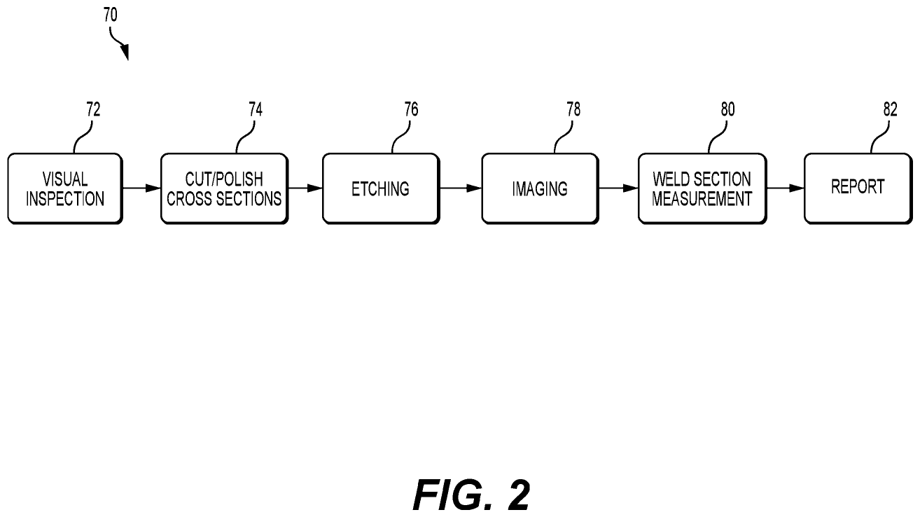

FIG. 2 shows a flow diagram illustrating steps in a first method 70 for sectional analysis of welds. The first method 70 can be performed by one or more controllers, such as the first processor 32 and/or the second processor 64. As can be appreciated in light of the disclosure, the order of operation within the method is not limited to the sequential execution as illustrated in FIG. 2, but may be performed in one or more varying orders as applicable and in accordance with the present disclosure.

The first method 70 includes performing a visual inspection of the weld 10 at 72. The visual inspection may be performed manually (i.e. by a human operator) and/or automatically (i.e. by a computer vision system). The visual inspection may be used to identify external defects in the weld 10, such as a misplacement, cracking, etc.

The first method 70 also includes cutting and polishing the weld 10 to obtain one or more cross-sections of the weld 10 at step 74. Step 74 may include manual and/or automated operations.

The first method 70 also includes etching the one or more cross-sections of the weld 10 to produce an etched cross-section at step 76. Step 76 may include manual and/or automated operations. The etched cross-section may enhance visibility of boundaries between constituent pieces of the weld 10, such as two or more metal pieces and/or weld material joining the two or more metal pieces.

The first method 70 also includes imaging the etched cross-section of the weld 10 at step 78. Step 78 may include using a camera, such as a digital camera to produce image data representing the etched cross-section of the weld 10. The image data may be used for further manual and/or automated inspection processing. In some embodiments, the image data may be stored for future use.

The first method 70 also includes section measurement of the weld 10 at step 80. Step 80 may include automatically determining one of more measurements of the weld 10 based on the image data provided at step 78.

The first method 70 also includes generating a report regarding the weld 10 at step 82. Step 82 may include comparing the one of more measurements of the weld 10 to predetermined values to determine if the weld 10 meets specifications or requirements. Generating the report may include generating one or more graphic representations of the measurements, such as lines overlying an image of the cross-section of the weld 10. The report may indicate one or more characteristics that are within or that are outside of predetermined ranges (e.g., pass/fail) for each of one or more corresponding measurements.

In some embodiments, steps 72-78 of the first method 70 may be performed by a human operator using manual processes. In some embodiments, steps 80-82 of the first method 70 may be performed using automated processes. However, one or more of the steps 72-82 of the first method 70 may be performed in another way and in accordance with the present disclosure.

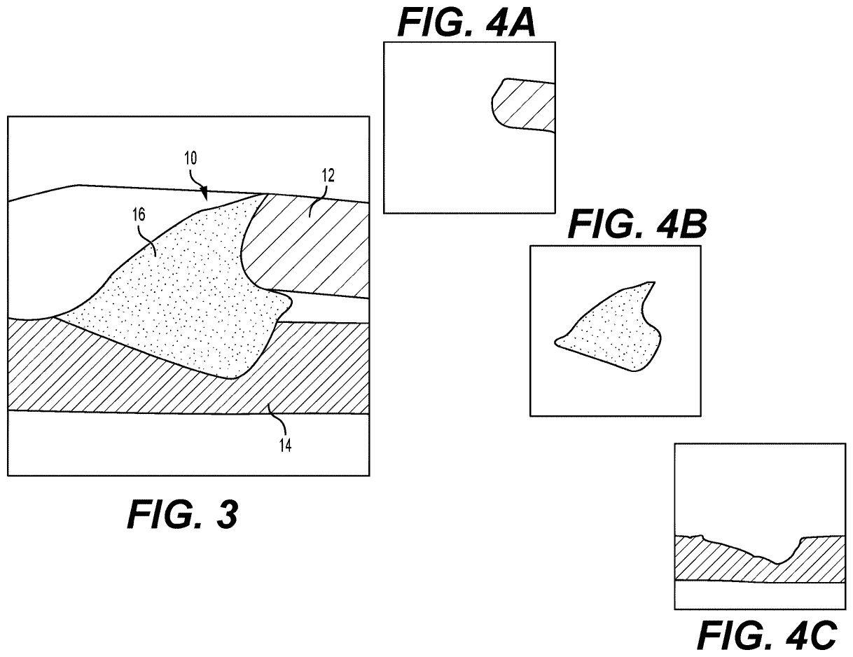

FIG. 3 shows a cross-sectional image of a weld 10 connecting two workpieces 12, 14, and with weld material 16 joining the two workpieces 12, 14. The weld material 16 may include a combination of material added during the welding process and/or material from one or both of the workpieces 12, 14 that is melted or otherwise altered in forming the weld 10.

FIGS. 4A-4C show three isolated body segments 12, 14, 16 based on the cross-sectional image of FIG. 3. FIG. 4A shows a first metal piece 12 of the workpieces 12, 14 that is joined at the weld 10. FIG. 4B shows the weld material 16, and FIG. 4C shows the second metal piece 14 of the workpieces 12, 14 that is joined at the weld 10.

The thee body segments 12, 14, 16 may be isolated using a machine learning technique, which may include, for example, a supervised learning (SL) technique, an unsupervised learning (UNS) technique, or a reinforcement technique. The machine learning technique may be implemented using one or more machine learning frameworks, such as Tensorflow or PyTorch. In some embodiments, the machine technique may include one or more neural networks, such as a convolutional neural network (CNN), a recurrent neural network (RNN), a feedforward neural network, etc. In some embodiments, a specific model of neural network may be used to implement the machine learning technique. Examples of such specific model may include, for example, U-net, U-net++, FPN, PAN, DeepLapV3, DeepLabV3+. In some embodiments, one or more supporting libraries may be used to implement the machine learning technique. Examples of such supporting libraries include, for example, Numpy, Sympy, CV2, Scikit-Image, Pandas, Sklearn, Poutyne, Albumentations, Torchmetrics, Imgaug, and Openpyxl.

In one example embodiment, one or more neural networks, such as convolutional neural networks (CNNs) may be used to classify the body segments 12, 14, 16 by recognizing features of the body segments 12, 14, 16. The one or more neural networks may then segment or isolate the body segments 12, 14, 16. U-Net CNNs may be employed for this function in the automated inspection system 20. A U-Net CNN can localize and distinguish borders by classification on every pixel. An open-source Python library with pre-trained backbones may be utilized for model training the U-Net CNNs.

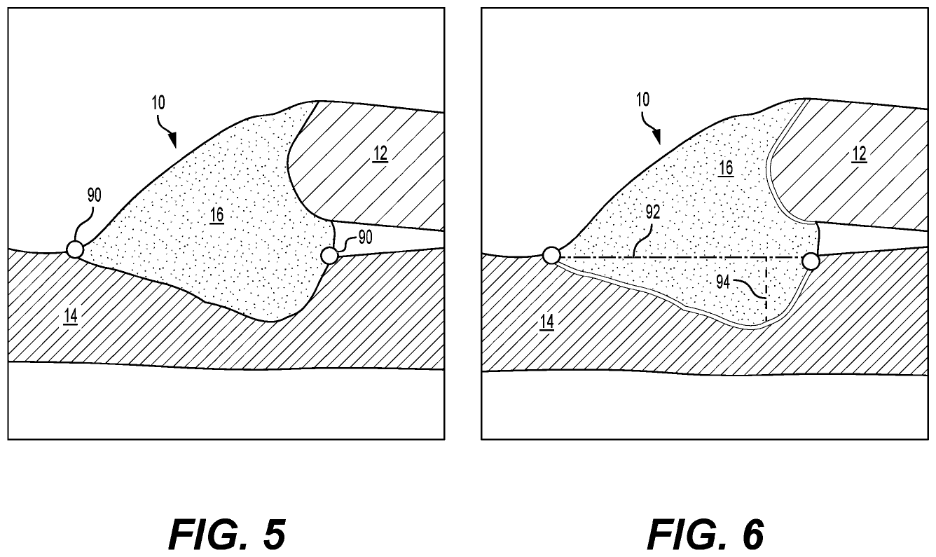

FIG. 5 shows a reassembled image including the three body segments 12, 14, 16 of FIGS. 4A-4C, and with key points 90 in the weld 10 identified. The key points 90 represent intersections between the body segments 12, 14, 16 at predetermined locations. The key points 90 may be discerned from the image of the weld 10 using logical algorithms.

FIG. 6 shows the reassembled image of FIG. 5 and with lines 92, 94 indicating measurements of characteristics of the weld 10. The measurements may be determined by converting a number of pixels in the image into a linear measurement, such as millimeters (mm). For example, the system and method of the present disclosure may be configured to determine a weld penetration depth 92 by performing the following steps: 1) determining the key points 90 between the weld material 16 and the second metal piece 14 at each of two points on the periphery of the weld 10; 2) drawing a first line 92 connecting the two key points 90; 3) searching for a deepest point on the weld boundary between the weld material 16 and the second metal piece 14 and perpendicular to the first line 92; and calculating a distance between the deepest point and the first line 92 as indicated by the second line 94.

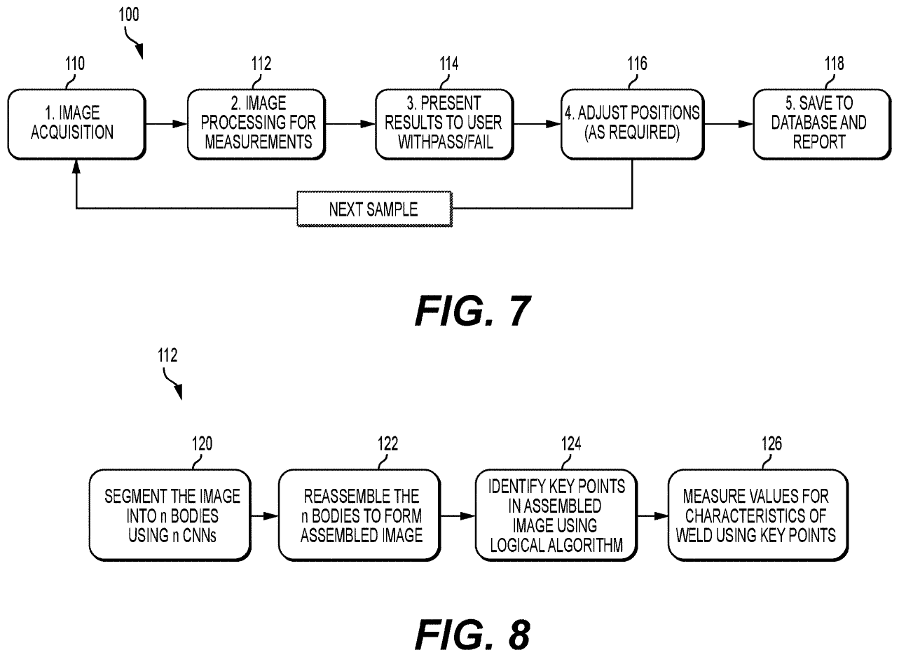

FIG. 7 shows a flow chart of steps in a second method 100 for automated inspection of welds 10, in accordance with the present disclosure. The second method 100 can be performed by one or more controllers, such as the first processor 32 and/or the second processor 64. As can be appreciated in light of the disclosure, the order of operation within the method is not limited to the sequential execution as illustrated in FIG. 7, but may be performed in one or more varying orders as applicable and in accordance with the present disclosure.

The second method 100 includes acquiring an image of a cross-section of the weld 10 at step 110.

The second method 100 also includes automatically processing the acquired image to determine measurements of characteristics of the weld 10 at step 112.

The second method 100 proceeds with presenting results of the measurements to a user at step 114. The presented results may include an indication of pass or fail for one or more of the characteristics of the weld 10 that were measured. In some embodiments, the presented results may include an indication of pass or fail for the entire weld, which may be determined based on comparing the results of the measurements with predetermined allowable tolerances for one or more different characteristics of the weld 10.

The second method 100 also includes adjusting positions at step 116. For example, the automated inspection system 20 may prompt the user to provide one or more further cross-sections of the weld 10 to enable the automated inspection system 20 to measure characteristics of the weld 10 not shown or otherwise undetermined in previous images. The second method 100 may loop through steps 110-116 for several iterations until all of the characteristics of all of the welds 10 for a given test are completed. The operator can adjust actual measurements within a single sample. The process may repeat for several samples in the set. A set may contain welds from a same product that is being tested.

In some embodiments, steps 110, 114, and 116 of the second method 100 may be performed, at least in part, by a human operator using the user interface 30. In some embodiments, step 112 of the second method 100 may be performed using automated processes. However, one or more of the steps 110-116 of the second method 100 may be performed in another way and in accordance with the present disclosure. In some embodiments, step 112 of the second method 100 may be performed, partially or entirely, using automated processes.

The second method 100 also includes saving the measurements of the characteristics for all of the welds for a given test to a database and generating a report of the measurements at step 118. In some embodiments, step 118 may be performed, at least in part, by a human operator using the user interface 30. For example, the user interface 30 may present a list of options for saving the measurements of the characteristics, such as a selection of measurements to be saved, naming, notes, etc. Alternatively or additionally, step 118 may be performed entirely or in part using automated processes.

FIG. 8 shows a flows chart of sub-steps for performing step 112 of automated image processing in the second method 100 of FIG. 7. Step 112 includes segmenting the image into n number of bodies at sub-step 120, where n is an integer number corresponding to a predetermined number of bodies or components that comprise the weld 10. Sub-step 120 may be performed using one or more convolutional neural networks (CNNs). In some embodiments, sub-step 120 may employ n number of the CNNs, with each of the CNNs being configured to determine a corresponding body from the image. An example of sub-step 120 is shown in the progression from FIG. 3 to FIGS. 4A-4C.

Step 112 also includes reassembling the bodies to form an assembled image at sub-step 122. An example of the assembled image is shown in FIG. 5.

Step 112 also includes identifying key points in the assembled image at sub-step 124. For example, and with reference to FIG. 6, sub-step 124 may include determining the key points 90 between the weld material 16 and the second metal piece 14 at each of two points on the periphery of the weld 10.

Step 112 also includes measuring values for characteristics of the weld using the key points at sub-step 126. For example, and with reference to FIG. 6, sub-step 124 may include calculating a distance between the deepest point and the first line 92 as indicated by the second line 94. Sub-step 126 may further include converting the measured distance from a number of pixels to a linear distance, such as millimeters. Additionally or alternatively, sub-step 126 may include determining an angular measurement, a two-dimensional area, a radius, a circumference, or a number of features, such as inclusions or pores, within a given area. The number of features within a given area may indicate, for example, a porosity of the weld.

In some embodiments, the system and method of the present disclosure may also include determining, based on the body segments, a characteristic indicative of a defect in the weld. For example, the system may be configured to identify presence of porosity and/or one or more inclusions, such as slag or silicate inside the weld. Additionally or alternatively, the characteristic may be indicative of other types of defects, such as cracks, burn-through, distortion, undercut, etc.

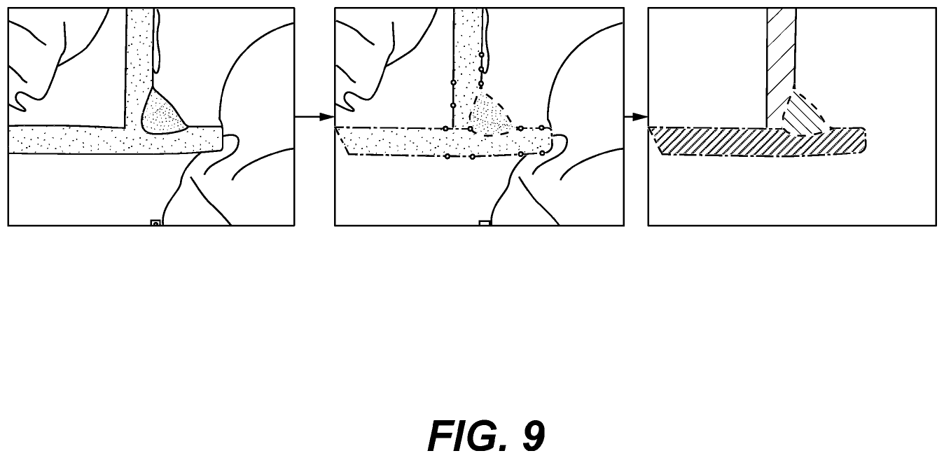

FIG. 9 shows a series of training images used for training an Artificial Intelligence (AI) model, in accordance with the present disclosure.

To train the segmentation model, a “Ground Truth” must be defined by annotating the training images. This “Ground Truth” acts as the target for the AI model. Error is measured against the ground truth after each training epoch (loop), and the Neural Net weights are adjusted accordingly. Test sets are used to measure the quality and accuracy of the models and algorithms. These test sets are used to tune and optimize parameters of the software.

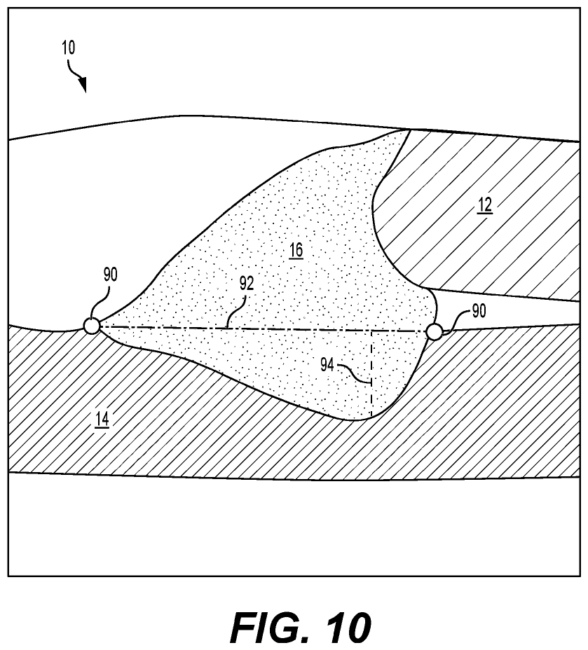

FIG. 10 shows a cross-sectional image of a weld, illustrating features of a semantic segmentation method in accordance with the present disclosure.

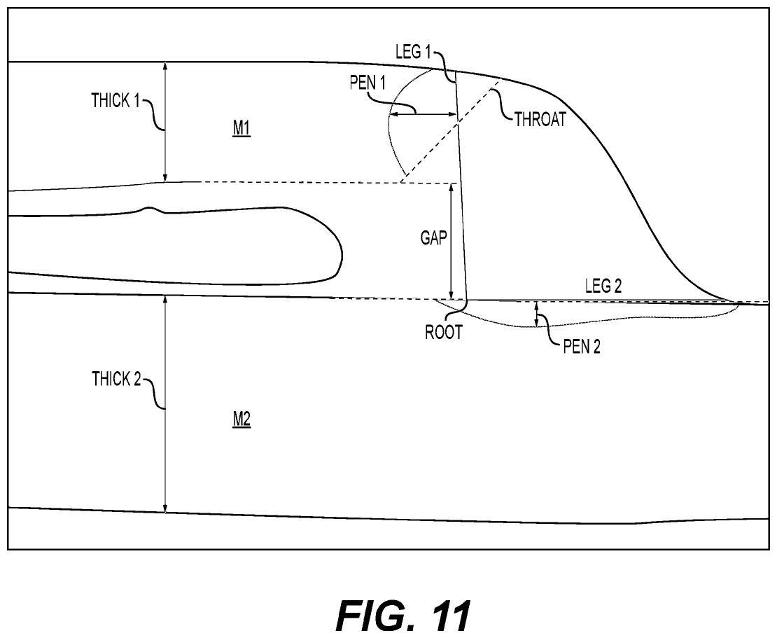

FIG. 11 shows a cross-sectional image of a first weld between parts M1, M2 that are disposed generally parallel to one another, illustrating weld characteristics to be measured by the method and system of the present disclosure.

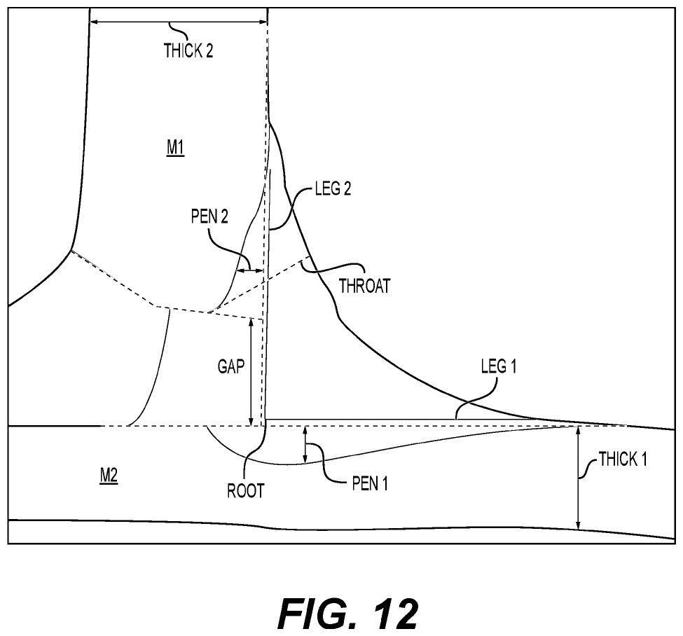

FIG. 12 shows a cross-sectional image of a second weld between parts M1, M2 that are disposed generally perpendicular to one another, illustrating weld characteristics to be measured by the method and system of the present disclosure.

Table 1, below, lists characteristics of a weld and that may be measured by the method and system of the present disclosure.

TABLE 1

| Number | Name | Measurement Procedure |
|---|---|---|
| 1 | M1 MATERIAL | Thickness of sheared material |
| | THICKNESS | |
| 2 | M2 MATERIAL | Thickness of material which passes |
| | THICKNESS | through both sides of the weld |
| 3 | ROOT | Leg 1/Leg 2 intersection to |
| | PENETRATION | deepest penetration point |
| 4 | LEG 1 | Deepest penetration depth into M1 |
| | PENETRATION | |
| 5 | LEG 2 | Deepest penetration depth into M2 |
| | PENETRATION | |
| 6 | ACTUAL | Root penetration intersection to face |
| | THROAT | |
| 7 | LEG LENGTH | Length of fusion only, starting |
| | FUSION 1 | from root corner |
| 8 | LEG LENGTH | Length of fusion only, starting |
| | FUSION 2 | from root corner |
| 9 | GAP | Gap between M1 & M2, at joint |
| | | side, not backside |

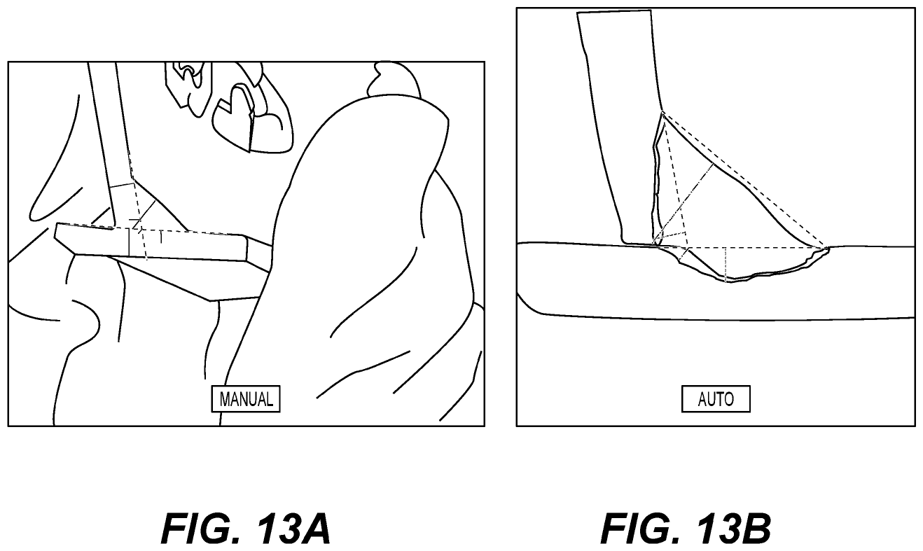

FIG. 13A shows a cross-sectional image of a weld joining two metal pieces, with lines indicating measurements determined by a manual inspection process. FIG. 13B shows the cross-sectional image of the weld of FIG. 13A, with lines indicating measurements determined by the automated system and method in accordance with the present disclosure.

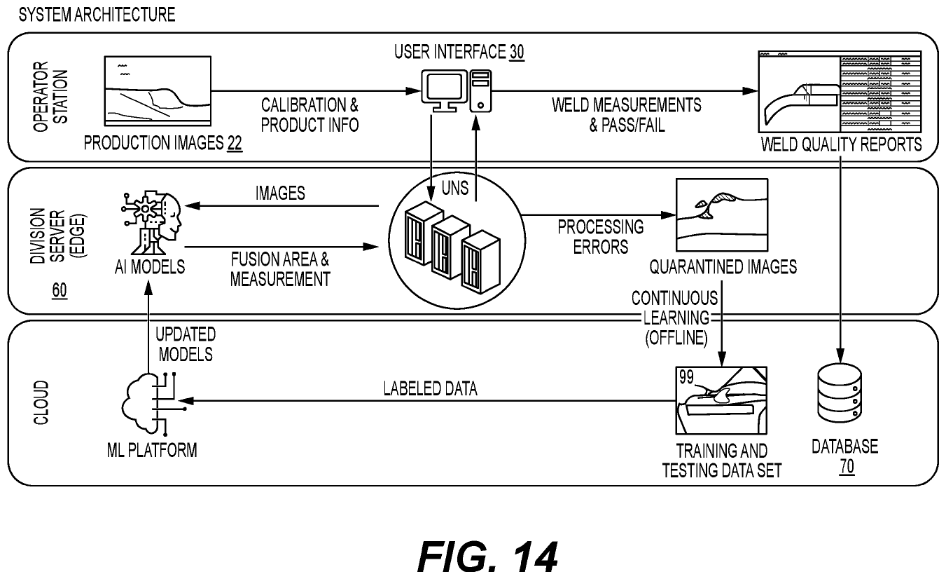

FIG. 14 shows an architecture diagram of the system for automated sectional analysis of joints, such as welds, in accordance with the present disclosure.

The present disclosure provides a method for analyzing a cross-section of a joint between two workpieces. The method includes: capturing, using a camera, an image of the cross-section of the joint; analyzing, using a machine learning technique, the image of the cross-section of the joint to classify two or more body segments that comprise the joint; isolating, using the machine learning technique, the body segments of the joint; reassembling the body segments to form an assembled image of the joint; identifying key points in the assembled image of the joint; and measuring, using the key points, a value for a characteristic of the joint.

In some embodiments, the joint comprises a weld.

In some embodiments, the joint includes one of a laser weld, a resistance weld, or a gas metal arc weld (GMAW).

In some embodiments, the joint comprises a mechanical fastener.

In some embodiments, the mechanical fastener comprises a self-piercing rivet (SPR).

In some embodiments, the machine learning technique includes one or more neural networks.

In some embodiments, the one or more neural networks include an artificial neural network (ANN).

In some embodiments, the one or more neural networks include a convolutional neural network (CNN).

In some embodiments, the one or more neural networks comprises a convolutional neural network (CNN) associated with each body segment of the two or more body segments.

In some embodiments, analyzing the image of the cross-section of the joint to classify two or more body segments that comprise the joint includes localizing and distinguishing borders between the two or more body segments of the joint.

In some embodiments, measuring the value for the characteristic of the joint further includes determining one of a linear distance, an angular measurement, a two-dimensional area, a radius, or a number of features within a given area.

In some embodiments, measuring the value for the characteristic of the joint further includes determining a number of pixels between points associated with the characteristic of the joint and calculating a linear distance between points associated with the characteristic and based on the number of pixels between the points associated with the characteristic of the joint.

In some embodiments, the method further includes training the one or more neural networks to identify the two or more body segments of the joint and to evaluate a performance of the one or more neural networks to identify the two or more body segments of the joint.

In some embodiments, the method further includes comparing the value for the characteristic of the joint with one or more predetermined threshold values to determine if the characteristic of the joint is within acceptable limits.

In some embodiments, the method further includes storing the assembled image of the joint and the value for the characteristic of the joint in a database.

In some embodiments, the characteristic of the joint is one of a plurality of characteristics of the joint, and wherein the method further comprises measuring, using the key points, values for each of the plurality of characteristics of the joint.

In some embodiments, the method further includes generating, by an automated process, a report regarding the joint, the report including the values for each of the plurality of characteristics of the joint.

In some embodiments generating the report includes generating a graphic representation associated with the plurality of characteristics of the joint.

The present disclosure also provides a method for analyzing a cross-section of a joint between two workpieces. The method includes: capturing, using a camera, an image of the cross-section of the joint; analyzing, using a machine learning technique, the image of the cross-section of the joint to classify two or more body segments that comprise the joint; isolating, using the machine learning technique, the body segments of the joint; reassembling the body segments to form an assembled image of the joint; and determining, based on the body segments, a characteristic indicative of a defect in the joint.

The present disclosure also provides a system for automated sectional analysis of a joint between two workpieces. The system includes: a processor; and a memory that includes instructions. The instructions, when executed by the processor, cause the processor to: analyze, using a machine learning technique, an image of a cross-section of the joint to classify two or more body segments that comprise the joint; isolate, using the machine learning technique, the body segments of the joint; reassemble the body segments to form an assembled image of the joint identify key points in the assembled image of the joint; and measure, using the key points, a value for a characteristic of the joint.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for analyzing a cross-section of a joint between two workpieces, comprising:
capturing, using a camera, an image of the cross-section of the joint;
analyzing, using a machine learning technique, the image of the cross-section of the joint to classify two or more body segments that comprise the joint;
isolating, using the machine learning technique, the body segments of the joint;
reassembling the body segments to form an assembled image of the joint;
identifying key points in the assembled image of the joint; and
measuring, using the key points, a value for a characteristic of the joint.

2. The method of claim 1, wherein the joint comprises a weld.

3. The method of claim 1, wherein the joint includes one of a laser weld, a resistance weld, or a gas metal arc weld (GMAW).

4. The method of claim 1, wherein the machine learning technique includes one or more neural networks.

5. The method of claim 4, wherein the one or more neural networks include an artificial neural network (ANN).

6. The method of claim 4, wherein the one or more neural networks include a convolutional neural network (CNN).

7. The method of claim 4, wherein the one or more neural networks comprises a convolutional neural network (CNN) associated with each body segment of the two or more body segments.

8. The method of claim 4, further comprising training the one or more neural networks to identify the two or more body segments of the joint and to evaluate a performance of the one or more neural networks to identify the two or more body segments of the joint.

9. The method of claim 1, wherein analyzing the image of the cross-section of the joint to classify two or more body segments that comprise the joint includes localizing and distinguishing borders between the two or more body segments of the joint.

10. The method of claim 1, wherein measuring the value for the characteristic of the joint further includes determining one of a linear distance, an angular measurement, a two-dimensional area, a radius, or a number of features within a given area.

11. The method of claim 1, wherein measuring the value for the characteristic of the joint further includes determining a number of pixels between points associated with the characteristic of the joint and calculating a linear distance between points associated with the characteristic and based on the number of pixels between the points associated with the characteristic of the joint.

12. The method of claim 1, wherein the characteristic of the joint is one of a plurality of characteristics of the joint, and wherein the method further comprises measuring, using the key points, values for each of the plurality of characteristics of the joint.

13. The method of claim 12, further comprising generating, by an automated process, a report regarding the joint, the report including the values for each of the plurality of characteristics of the joint.

14. A method for analyzing a cross-section of a joint between two workpieces, comprising:
capturing, using a camera, an image of the cross-section of the joint;
analyzing, using a machine learning technique, the image of the cross-section of the joint to classify two or more body segments that comprise the joint;
isolating, using the machine learning technique, the body segments of the joint;
reassembling the body segments to form an assembled image of the joint; and
determining, based on the body segments, a characteristic indicative of a defect in the joint.

15. A system for automated sectional analysis of a joint between two workpieces, comprising:
a processor; and
a memory that includes instructions that, when executed by the processor, cause the processor to:
analyze, using a machine learning technique, an image of a cross-section of the joint to classify two or more body segments that comprise the joint;
isolate, using the machine learning technique, the body segments of the joint;
reassemble the body segments to form an assembled image of the joint;
identify key points in the assembled image of the joint; and
measure, using the key points, a value for a characteristic of the joint.

16. The method of claim 1, wherein the joint comprises a mechanical fastener.

17. The method of claim 16, wherein the mechanical fastener comprises a self-piercing rivet (SPR).

18. The method of claim 1, further comprising comparing the value for the characteristic of the joint with one or more predetermined threshold values to determine if the characteristic of the joint is within acceptable limits.

19. The method of claim 1, further comprising storing the assembled image of the joint and the value for the characteristic of the joint in a database.

20. The method of claim 13, wherein generating the report includes generating a graphic representation associated with the plurality of characteristics of the joint.
